(19) United States
(12) Patent Application Publication
(10) Pub. No.: US 2023/0182332 A1
(43) Pub. Date: Jun. 15, 2023

(54) NASAL HAIR TRIMMER

(71) Applicant: BOCAS CO, LTD, Incheon (KR)

(72) Inventor: Jeong Sik HAN, Incheon (KR)

(73) Assignee: BOCAS CO, LTD, Incheon (KR)

(21) Appl. No.: 17/563,098

(22) Filed: Dec. 28, 2021

(30) Foreign Application Priority Data
Dec. 13, 2021 (KR) 10-2021-0177963

(51) Int. Cl. B26B 13/08

(52) U.S. Cl. CPC B26B 13/08; B26B 13/16

(57) ABSTRACT

Disclosed is a nasal hair trimmer which removes a large amount of nose hair by safely inserting the nasal hair trimmer into a nostril using only a small number of operations. The nasal hair trimmer includes two cutting plates, each including two or three cutting heads and having a size capable of entering a nostril, wherein the two cutting plates are connected to each other by a shaft pin so as to swing while overlapping each other in a state of being parallel to each other, and wherein, when the cutting heads of the two cutting plates swing relative to each other, cutting heads neighboring each other are moved toward each other so as to cut nose hair.

### BACKGROUND OF THE INVENTION

### Field of the Invention

The present invention relates to a nasal hair trimmer, and more particularly to a nasal hair trimmer configured to cut nose hair using a method of overlapping two cutting plates, each having two or more cutting blades and having a size capable of entering a nostril, to swing in a manner of scissors.

### Description of the Related Art

This section provides background information related to the content of the present application, and does not necessarily constitute the related art to the present application.

Nose hair serves to filter out foreign substances such as dust that enter the respiratory tract through the nostrils. Nose hair grows inside the nostrils and is partially exposed outside the nostrils, conveying an unsightly image.

For this reason, a cosmetic device (a nasal hair trimmer) for trimming nose hair is used.

A nasal hair trimmer may be classified into a scissors type, a circular type, and a tongs type, depending on the trimming manner and on the form thereof.

As an example of the scissors type, Korean Utility Model Registration No. 20-0470246 discloses scissors for cutting nose hair including two bodies, each of which includes a ring-shaped gripping portion provided at one end thereof and into which a finger is fitted, a cutting portion formed with a scissor blade for cutting nose hair at the other end, and an extending portion extending in a longitudinal direction between the gripping portion and the cutting portion, and a coupling portion configured to rotatably couple the two bodies in the extending portion. Here, each of the extending portions is divided into an arm provided at the gripping-portion side and a leg provided at the cutting-portion side with respect to the coupling portion, and each of the cutting portions includes a flat cutting surface, which faces a corresponding flat cutting surface and overlapping the corresponding flat cutting surface when the cutting portions move in a cutting direction, and a curved surface in a cross-section in which the cutting portion is cut in a plane perpendicular to the longitudinal direction of the body, enclosing the cross-section together with the cutting surface to form an arc-shaped cross-section, wherein at least a portion of the curved surface is provided with a protective surface implemented as an inclined surface on which a cutting edge is formed, and a cutting line formed as a straight edge as a boundary between the cutting surface and the protective surface at the tip of the cutting surface in the cutting direction and provided with a scissor blade formed therearound. A maximum vertical distance from the cutting surface to the protective surface is a predetermined distance longer than a width of the leg in a direction perpendicular to the cutting surface.

As an example of the circular type, Korean Patent Registration No. 10-1795626 discloses a nose hair cutter configured to cut nose hair and having a structure in which a rotating inner body having an inner cutting portion is fitted inside a fixed outer body having an outer cutting portion so as to allow the inner cutting portion of the rotating inner body to be disposed to correspond to the outer cutting portion of the fixed outer body, wherein the outer cutting portion includes a plurality of first cutting pieces and first slits alternately formed around an upper circumference of the fixed outer body, and the inner cutting portion includes a plurality of second cutting pieces and second slits alternately formed around an upper circumference of the rotating inner body, and wherein the rotating inner body rotates relative to the fixed outer body in the state in which the first cutting pieces and the first slits in the outer cutting portion and the second cutting pieces and the second slits in the inner cutting portion are aligned with each other, so as to allow nose hair to be cut by the first cutting pieces and the second cutting pieces. Here, the second cutting pieces and the second slits in the inner cutting portion are disposed to face each other, and an inner guide portion of the second cutting piece is connected to a lower inclined surface of the second slit at a center thereof, and an upper end of the lower inclined surface of the first slit of the outer cutting portion is disposed lower than a lower end of the lower inclined surface of the second slit so as to guide nose hair to the lower inclined surface of the first slit through the lower inclined surface of the second slit, thereby cutting the nose hair by the first cutting piece and the second cutting piece, wherein the inner guide portion includes a steeply inclined portion formed from an upper inner end of the second cutting piece and a mildly inclined portion that is bent at a lower end of the steeply inclined portion and connected to the center.

As an example of the tongs type, Korean Patent Publication No. 10-2013-0005377 discloses a non-powered nose hair trimmer including a first cutting member including a first handle portion for holding, a circular cutting ring portion formed at an end of the first handle portion, and a first coupling portion formed at the opposite side of the cutting ring portion in the first handle portion, and a second cutting member including a second handle portion for holding, a cutting plate portion formed at an end of the second handle portion, and a second coupling portion formed at the opposite side of the cutting plate portion in the second handle portion. The first coupling portion of the first cutting member and the second coupling portion of the second cutting member are bonded to each other by spot welding, the surface of the circular cutting ring portion and the surface of the cutting plate portion are formed in such a way that the two surfaces are inclined at a preset angle on the basis of the lateral section so as to meet each other, the cutting plate portion is formed in such a way that the thickness gradually decreases when viewed in a lateral section as it approaches the other end of the second coupling portion, and the inner surface of the cutting plate portion is formed into the shape of a circular arc with a straight portion at a lower side thereof, wherein the straight portion is formed at a boundary portion at which the inner surface of the second handle portion and the cutting plate portion meet within a manufacturing tolerance.

Korean Patent Publication No. 10-1998-0008475 discloses an unpowered nostril hair cutter manufactured in a manner of folding a stainless steel plate having a good degree of elasticity and strength to form a folding portion at a lower center thereof while forming handle parts closely facing each other, and then integrating a circular cutting tube, which has an inclined surface on an outer rim thereof and faces inwards, on an upper end of the handle part at one side, and integrating a circular cutting tube, also having an inclined surface on an outer rim thereof and facing inwards, on an upper end of the handle part at the opposite side, wherein an outer diameter of the circular cutting tube is set smaller than an inner diameter of the other circular cutting tube, so that when holding the opposing handle parts in the hand and pressing the same inwards, the circular cutting tube is inserted slightly into the other circular cutting tube, thereby cutting nose hair located between opposing circular cutting tubes.

The conventional nose hair trimmers described above have the following problems.

In the case of the scissors type, two blades are moved toward each other to cut nose hair, but when the two blades reciprocate within a small range, this operation is very cumbersome, and the amount of nose hair that is cut is not great. Moreover, the range within which the two blades are spread apart cannot be limited, whereby the skin of the nostril is vulnerable to injury.

In the case of the circular type, a plurality of blades is arranged in a circumferential direction, but cutting of nose hair is performed by two neighboring cutting blades. Since the plurality of cutting blades is arranged in the circumferential direction, the space between neighboring cutting blades is small, thereby hindering entry of nose hair into the space between the cutting blades, thus making it difficult to trim nose hair. In addition, it is inconvenient and difficult to trim nose hair, which sticks out from nostrils, from outside the nose. Moreover, the shape of the circular blade only reflects the shape of the nostril, and cannot be the optimal shape for cutting nose hair, and since it is not possible to cut nose hair while changing the direction of the circular blade inside the nostril, the efficiency with which nose hair is trimmed is not good.

In the case of the tongs type, nose hair is cut in the state in which the nose hair is placed between the inner blade portion and the outer blade portion (a circular cutting ring portion and a cutting plate portion or a circular cutting tube) formed at the tip of the tongs. In addition, since it is difficult to properly align the blade portions at the correct position, nose hair is caught between the blade portions and often plucked out. For this reason, the nose hair is pulled out with the follicle from the nostril, causing severe pain. Moreover, the manner of inserting the tongs into the nostril to hold nose hair is also inconvenient, thereby making it less practical.

As a result, there is a need for a new type of nose hair trimmer that can trim a large amount of nose hair in a single operation without causing pain.

### RELATED ART DOCUMENTS

### Patent Documents

Korean Utility Model Registration No. 20-0470246

Korean Patent Registration No. 10-1795626

Korean Patent Publication No. 10-2013-0005377

Korean Patent Publication No. 10-1998-0008475

### SUMMARY OF THE INVENTION

Therefore, the present invention has been made in view of the above problems, and it is an object of the present invention to provide a nasal hair trimmer capable of removing a large amount of nose hair in a small number of operations in a state of being inserted into a nostril.

In accordance with the present invention, the above and other objects can be accomplished by the provision of a nasal hair trimmer including two cutting plates each including two or three cutting heads and having a size capable of entering a nostril, wherein the two cutting plates are connected to each other by a shaft pin so as to swing while overlapping each other in a state of being parallel to each other, and wherein, when the cutting heads of the two cutting plates swing relative to each other, cutting heads neighboring each other are moved toward each other so as to cut nose hair.

The cutting heads may include a first cutting head and a second cutting head, each of which has three cutting heads arranged in a line at regular intervals. Here, the state in which the first cutting head and the second cutting head overlap each other is an initial state.

The nasal hair trimmer may further include a limiting means configured to limit a range within which the first cutting head and the second cutting head swing. Here, the limiting means allows the first cutting head and the second cutting head to be maintained in a state of overlapping each other regardless of whether the first cutting head and the second cutting head are moved toward each other or away from each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a nasal hair trimmer according to the present invention;

FIG. 2 is an exploded perspective view of the nasal hair trimmer according to the present invention;

FIG. 3 is a side view of the nasal hair trimmer according to the present invention;

FIGS. 4 and 5 are respective front views of the nasal hair trimmer according to the present invention;

FIG. 4 illustrates a state in which cutting blades are brought together;

FIG. 5 illustrates a state in which cutting blades are moved away from each other;

FIG. 6 is a view illustrating another example of a handle employed in the nasal hair trimmer according to the present invention; and

FIG. 7 is a view illustrating another example of the nasal hair trimmer according to the present invention.

### DETAILED DESCRIPTION OF THE INVENTION

In describing the present disclosure, if a detailed explanation of a related known function or construction is considered to unnecessarily obscure the gist of the present disclosure, such explanation will be omitted. In addition, terms to be described later are defined in consideration of functions in the present invention, and may vary according to intentions of users and operators or customs. Therefore, the definition thereof should be made based on the entire content of the present specification.

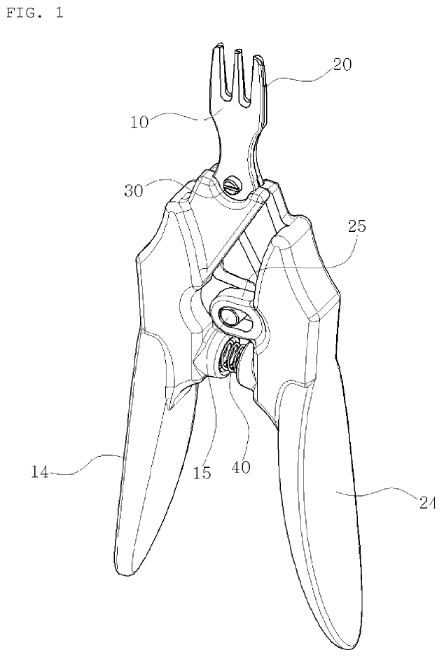

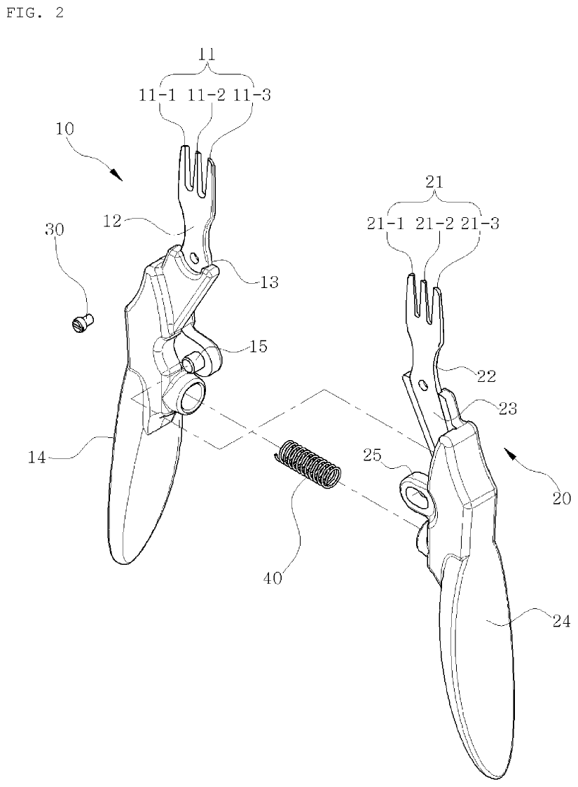

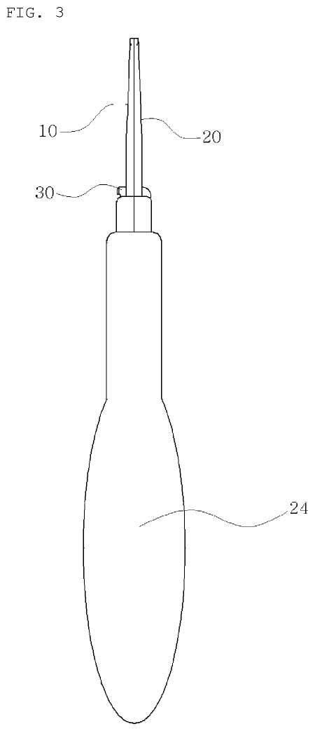

As illustrated in FIGS. 1 to 5, a nasal hair trimmer according to the present invention includes cutting plates (referred to as a first cutting plate 10 and a second cutting plate 20), each having a corresponding cutting head (referred to as a first cutting head 11 or a second cutting head 21) and connected to each other through a shaft pin 30. Here, the cutting plates swing in the direction in which the cutting plates are moved toward each other or away from each other by the force pressing one side of the shaft pin 30 so as to allow the first cutting head 11 and the second cutting head 21 to cut nose hair.

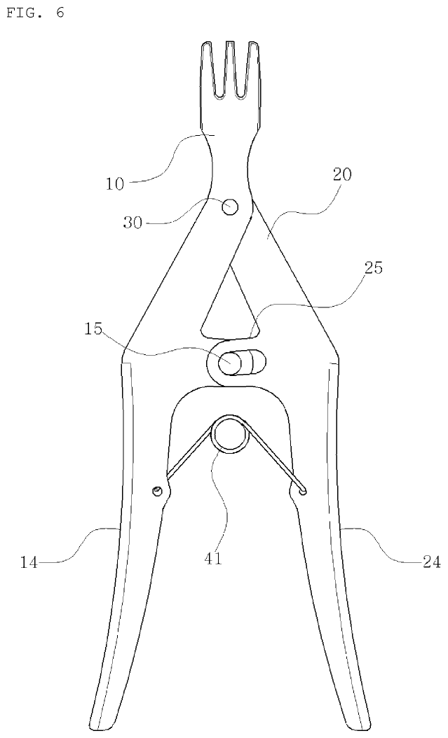

The first cutting plate 10 includes a first head portion 12 having the first cutting head 11, a first connecting portion 13 extending from the first head portion 12, and a first handle portion 14 coupled to a first connecting portion 13. The second cutting plate 20 includes a second head portion 22 having the second cutting head 21, a second connecting portion 23 extending from the second head portion 22, and a second handle portion 24 coupled to the second connecting portion 23. In addition, as illustrated in FIG. 6, each of the first handle portion 14 and the second handle portion 24 in the present invention may also be integrally formed with a corresponding one of the first connecting portion 13 and the second connecting portion 23.

The first cutting plate 10 and the second cutting plate 20 are thin plates, each of which has a pin hole therein at a portion between a corresponding one of the first cutting head 11 and the second cutting head 21 and a corresponding one of the first handle portion 14 and the second handle portion 24. Here, the portion is close to the first cutting head 11 or the second cutting head 21. Since the shaft pin 30 is fitted into the pinhole, the first cutting plate 10 and the second cutting plate 20 swing in opposite directions while overlapping each other when the first handle portion 14 and the second handle portion 24, each placed at one side of the shaft pin 30, are held and pressed, thereby cutting nose hair placed between the first cutting head 11 and the second cutting head 21.

Each of the first cutting head 11 and the second cutting head 21 includes two or three (preferably three, as shown in the drawings as an example) cutting heads. Each of the cutting heads has a pointed shape, a cross-sectional area of which decreases toward an end thereof, and the cutting heads are formed at regular intervals. The interval is the space within which nose hairs are placed.

Each of the first cutting head 11 and the second cutting head 21 is formed with a cutting blade on a side surface thereof. The cutting blade may be formed on both a left side surface and a right side surface of the corresponding cutting head, or may be formed on only one surface (the left side surface or the right side surface), which cuts nose hair. In other words, a left end of the first cutting head 11 and a right end of the second cutting head 21 may not be formed with a cutting blade.

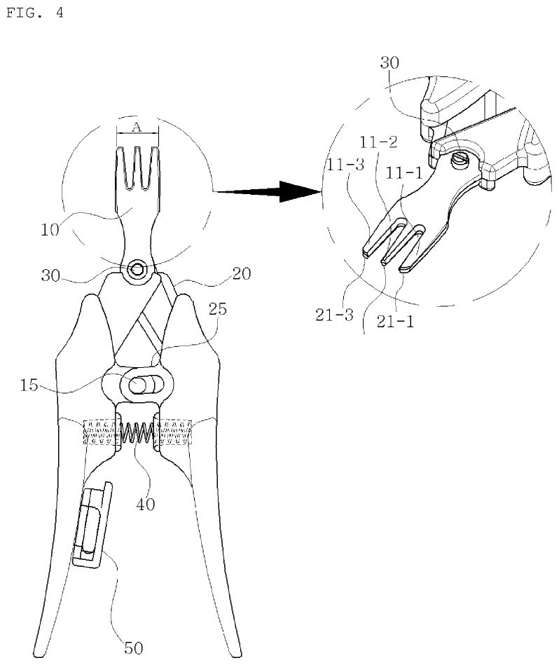

With this structure, the first head portion 12 and the second head portion 22 have a width A in which the first head portion 12 and the second head portion 22 can be naturally inserted into a nostril without excessively widening the nostril. The width A is 7 mm±10% in a state in which the three first cutting heads 11 overlap the three second cutting heads 21 on the same line, as illustrated in FIG. 4.

The three first cutting heads 11 and the three second cutting heads 21 are each arranged in a line at an interval within which nose hair is capable of being placed under the above-described width condition.

Due to the structure of the first cutting head 11 and the second cutting head 21, a space in each of the first cutting head 11 and the second cutting head 21 has a shape that narrows inwards. Accordingly, nose hair is gathered inwards, allowing efficient cutting to be performed by the cutting blades of the first cutting head 11 and the second cutting head 21.

The first cutting head 11 and the second cutting head 21 are formed in a round shape without sharp ends so as to avoid injury when handling the same or inserting the same into a nostril.

Here, it may also be possible for the left and right cutting heads 11-1, 11-3, 21-1, and 21-3 to have a round shape and for the central cutting head 11-2 and 21-2 to be sharp but formed shorter than the left and right cutting heads 11-1, 11-3, 21-1, and 21-3.

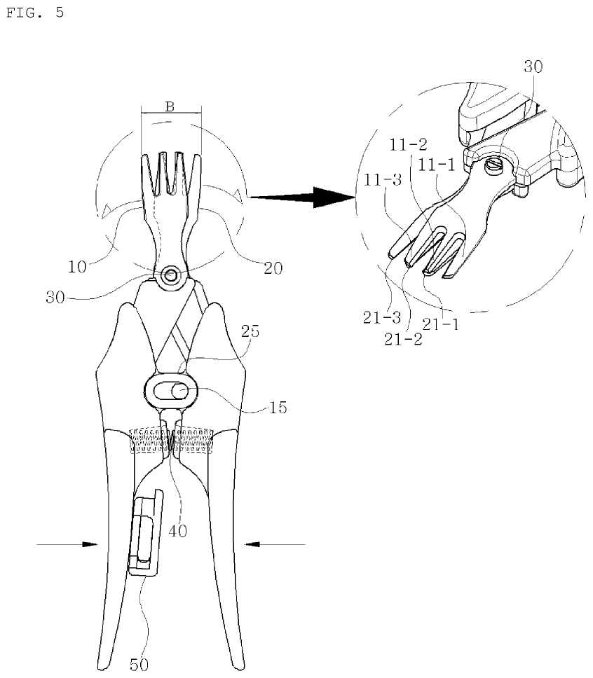

According to this width and structure, a width when the first head portion 12 and the second head portion 22 are moved away from each other, that is, a width B when the central and right cutting heads 11-2 and 11-3 of the first cutting head 11 overlap the left and central cutting heads 21-1 and 21-2 of the second cutting head 21, and the remaining cutting heads 11-1 and 21-3 are moved in opposite directions as illustrated in FIG. 5, is “10 mm±10%”.

In addition, end portions of the first and second cutting plates 10 and 20 may be chamfered so as not to interfere with the swinging of the first cutting plate 10 and the second cutting plate 20 while the same overlap each other.

The first connecting portion 13 and the second connecting portion 23 are formed to extend from a corresponding one of the first head portion 12 and the second head portion 22 at an angle such that the same are spaced apart from each other to secure a comfortable grip.

In order to allow the first cutting plate 10 and the second cutting plate 20 to be spread apart from each other only within a predetermined angle, a limiting means is employed.

The limiting means includes a rail 25, formed on the second handle portion 24, and a stopper 15, coupled to a boss portion formed on the first handle portion 14 and connected to the rail 25 so as to be movable along the rail 25.

The rail 25 has a shape of a hole penetrated in a front and rear direction, and opposite ends of the rail 25 constrain movement of the stopper 15.

Since the limiting means has a structure such that the stopper 15 is moved to the end of the rail 25 and cannot move any further, the limiting means restricts the swinging of the first head portion 12 and the second head portion 22.

In particular, the limiting means has an organic coupling relationship with the structure of the first and second cutting heads 11 and 21. With this relationship, the first cutting head 11 and the second cutting head 21 overlap each other when the first head portion 12 and the second head portion 22 are brought together, as illustrated in FIG. 4, and the first cutting head 11 and the second cutting head 21 also overlap each other when the first head portion 12 and the second head portion 22 are moved away from each other, as illustrated in FIG. 5. When the first head portion 12 and the second head portion 22 are moved away from each other, two cutting heads 11-2 and 11-3 of the first cutting head 11 overlap two cutting heads 21-1 and 21-2 of the second cutting head 21, but the cutting heads 11-1 and 21-3 on the left and right, respectively, do not overlap each other.

That is, due to the limiting means, the first cutting heads 11-1, 11-2, and 11-3 and the second cutting heads 21-1, 21-2, and 21-3 swing within a predetermined distance.

When the first head portion 12 and the second head portion 22 perform an operation of moving toward each other and moving away from each other, elastic force is applied in any one direction to make the operation easier, and this is possible due to an elastic member.

The elastic member is a coil spring 40. As illustrated in FIGS. 1 to 5, opposite longitudinal ends of the coil spring 40 are respectively supported by the first handle portion 14 and the second handle portion 24 so as to elastically support the first handle portion 14 and the second handle portion 24 in a direction in which the first handle portion 14 and the second handle portion 24 move away from each other, and eventually to elastically support the first head portion 12 and the second head portion 22, each placed at another side of the shaft pin 30, in a direction in which the first head portion 12 and the second head portion 22 are moved towards each other.

Each of the first handle portion 14 and the second handle portion 24 is formed with at least one of a groove and a protrusion, which supports opposite longitudinal sides of the coil spring 40.

The elastic member is not limited to the coil spring 40, and, as illustrated in FIG. 6, a leaf spring 41 may also be employed.

The coil spring 40 and the leaf spring 41 are employed not depending on whether the handle portion is an assembled type or an integral type, but freely, without regard to type.

To protect the first and second cutting heads 11 and 21 and to prevent injury caused by the first and second cutting heads 11 and 21 when storing the nasal hair trimmer, a cover 50 may be included.

The cover 50 may be in any form that maintains the state in which the first cutting head 11 and the second cutting head 21 are brought together and not spread apart, preferably in a form of a cap that covers the first and second cutting heads 11 and 21.

In order to prevent loss of the cover 50, which is removed from the first and second cutting heads 11 and 21 while trimming nose hair, a cover-accommodating portion 16 may be included.

The cover-accommodating portion 16 may have a shape of a groove into which the cover 50 is fitted, a shape of a protrusion fitted into the inside of the cover 50, or the like.

A method of trimming nose hair using the nasal hair trimmer according to the present invention is as follows.

1. Insert first and second head portions in nostril

The first handle portion 14 and the second handle portion 24 are held without pressing, and the first head portion 12 and the second head portion 22, which are brought together, are inserted into a nostril in the state in which the first cutting head 11 and the second cutting head 21 overlap each other.

In this way, the first cutting head 11 of the first head portion 12 and the second cutting head 21 of the second head portion 22 have a width smaller than when the first cutting head 11 of the first head portion 12 and the second cutting head 21 of the second head portion 22 are moved away from each other, thereby allowing the first and second head portions 12 and 22 to be easily inserted into the nostril without poking the skin around the nostril.

2. Cut nose hair

When pressing the first handle portion 14 and the second handle portion 24 in the direction in which the first handle portion 14 and the second handle portion 24 move toward each other, the first head portion 12 and the second head portion 22, each placed at another side of the shaft pin 30, swing in opposite directions. At this time, the first cutting heads 11-1, 11-2, and 11-3 and the second cutting heads 21-1, 21-2, and 21-3 overlap each other and cut nose hair placed therebetween.

When pressing the handle portions, the first handle portion 14 and the second handle portion 24 swing until the central cutting head and 11-2 and the right cutting head 11-3 of the first cutting head 11 overlap the central cutting head 21-2 and the left cutting head 21-1 of the second cutting head 21 through the action of the limiting means.

When the force applied to the handle portions is released, the first head portions 12 and the second head portion 22 are swung in opposite directions by the elastic force of the coil spring 40. Also at this time, the first cutting heads 11-1, 11-2, and 11-3 overlap the second cutting heads 21-1, 21-2, and 21-3 so as to cut nose hair placed therebetween.

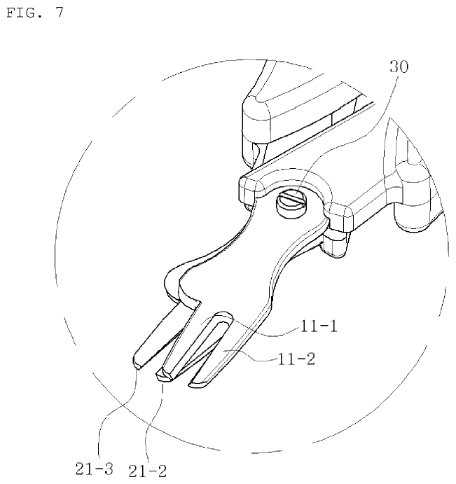

Meanwhile, according to the structure of the present invention, since the side surfaces of the first cutting head 11 and the second cutting head 21 serve as cutting blades, each of the first cutting head 11 and the second cutting head 21 may have two cutting heads, as illustrated in FIG. 7. Here, the first cutting head 11 has a left cutting head 11-1 and a central cutting head 11-2, and the second cutting head 21 has a central cutting head 21-2 and a right cutting head 21-3. That is, the first head portion 12 and the second head portion 22 have a structure in which the first cutting head 11 and the second cutting head 21 are oppositely eccentric with respect to the central cutting heads 11-2 and 21-2.

In other words, in the state in which the first cutting head 11 and the second cutting head 21 are moved away from each other, the central cutting head 11-2 overlaps the central cutting head 21-2, and only one of the cutting heads 11-1 and 21-3 is disposed on either the left side or the right side.

When swinging in this state, nose hair is cut by the central cutting head 11-2 of the first cutting head 11 and the right cutting head 21-3 of the second cutting head 21, and is cut by the left cutting head 11-1 of the first cutting head 11 and the central cutting head 21-2 of the second cutting head 21.

As is apparent from the above description, the present invention provides a nasal hair trimmer.

The nasal hair trimmer according to the present invention is formed in such a way that three (or two) cutting heads formed on each of two cutting plates collect nose hair in two spaces (spaces between cutting heads), and the nose hair collected in each space is cut by the cutting heads swinging in a direction in which the nose hair is collected, thereby cutting a large amount of nose hair in a single operation, and thus the time taken to trim nose hair may be shortened, and inconvenience may be eliminated.

Compared with the conventional scissors-type nose hair trimmer, in the nasal hair trimmer according to the present invention, a predetermined amount of nose hair is separated and placed in each of a plurality of spaces between the cutting heads, and by preventing the nose hair collected in the space from slipping out when the cutting heads are brought together, cutting efficiency is improved. In addition, since the distance between blades cannot be arbitrarily widened, the cutting plates can be inserted into a nostril comfortably and safely without careful attention.

Compared to the circular-type nose hair trimmer, since the nasal hair trimmer according to the present invention can cut nose hair by targeting nose hair while freely changing the direction and position of the nasal hair trimmer inside a nostril, it is more effective and easier to trim nose hair.

Compared to the tongs-type nose hair trimmer, the nasal hair trimmer according to the present invention can solve the problem of pain that is caused when nose hair is plucked out, and can easily trim a larger amount of nose hair than the amount that is removed with the tongs-type nose hair trimmer.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A nasal hair trimmer comprising:
two cutting plates each comprising two or three cutting heads and having a size capable of entering a nostril,
wherein the two cutting plates are connected to each other by a shaft pin so as to swing while overlapping each other in a state of being parallel to each other, and
wherein, when the cutting heads of the two cutting plates swing relative to each other, cutting heads neighboring each other are moved toward each other so as to cut nose hair.

2. The nasal hair trimmer of claim 1, wherein each of the cutting heads has a pointed shape, a cross-sectional area of which decreases toward an end thereof, and three cutting heads are arranged in a line at regular intervals.

3. The nasal hair trimmer of claim 1, further comprising a limiting means configured to limit a range within which the two cutting plates swing,
wherein the limiting means allows the cutting heads provided on the two cutting plates to be maintained in a state of overlapping each other when the two cutting plates are moved toward each other to have a minimum width and when the two cutting plates are moved away from each other to have a maximum width.

4. The nasal hair trimmer of claim 1, further comprising an elastic member configured to elastically support the two cutting plates in a direction in which the two cutting plates are moved toward each other or away from each other.

5. The nasal hair trimmer of claim 1, further comprising a cover that covers the cutting heads.

6. The nasal hair trimmer of claim 1, further comprising head portions each having cutting heads,
wherein the head portions have a width of 7 mm±10% when the two head portions are moved toward each other, and have a width of 10 mm±10% when the head portions are moved away from each other.

7. The nasal hair trimmer of claim 1, wherein one of the two cutting plates comprises a central cutting head and a left cutting head, and a remaining one of the two cutting plate comprises a central cutting head and a right cutting head.

8. The nasal hair trimmer of claim 2, further comprising an elastic member configured to elastically support the two cutting plates in a direction in which the two cutting plates are moved toward each other or away from each other.

9. The nasal hair trimmer of claim 2, further comprising a cover that covers the cutting heads.
